(19) United States
(12) Patent Application Publication
(10) Pub. No.: US 2014/0136248 A1
(43) Pub. Date: May 15, 2014

(54) TICKET TRANSFER FINGERPRINTING, SECURITY, AND ANTI-FRAUD MEASURES

(71) Applicant: Vendini, Inc., San Francisco, CA (US)

(72) Inventors: Marco Matarazzi, Gualdo Tadino (IT); Andrea Sprega, Gualdo Tadino (IT)

(73) Assignee: Vendini, Inc., San Francisco, CA (US)

(21) Appl. No.: 14/050,208

(22) Filed: Oct. 9, 2013

Related U.S. Application Data
(60) Provisional application No. 61/711,641, filed on Oct. 9, 2012.

(51) Int. Cl. G06Q 10/02

(52) U.S. Cl. CPC G06Q 10/02
USPC 705/5

(57) ABSTRACT

A method facilitates the purchase of a first ticket by way of a ticketing application. The ticketing application assigns a first fingerprint to the first ticket and stores it on a server. The first ticket is transferred to a recipient, and the first fingerprint is removed from the server. A second ticket with a second assigned fingerprint is issued to the recipient by way of the ticketing application. The second fingerprint is stored on the server.

### RELATED APPLICATIONS

The present application claims priority to U.S. provisional application No. 61/711,641, filed Oct. 9, 2012, the disclosure of which is incorporated by reference.

### BACKGROUND

1. Field of the Invention

The present invention generally concerns event ticket purchasing and processing. More particularly, the present invention relates to security and anti-fraud measures for ticket transfer.

2. Description of the Related Art

Traditionally, a paper ticket is issued and sold for each available seat at a live event or performance such as a concert, movie, ballet, or sporting event. A party wishing to attend the event is usually tasked with finding an available ticket, purchasing the ticket, receiving the purchased ticket (i.e., via e-mail, mail, or will call), and presenting the ticket to gain entry into the event. A problem may arise when a party wants to purchase multiple tickets for a group of attendees or when the attendee holds an issued ticket to an event but can no longer attend. When an attendee has purchased multiple tickets for a group of attendees, for example, the attendee is faced with the hassle of physically distributing the tickets to the attendees and, if applicable, collecting payment from each attendee for the same, both of which may involve a considerable amount of time, travel, and logistical planning. A similar situation occurs when the attendee can no longer attend the event. To prevent the ticket from going unused, the attendee can electronically transfer a purchased event ticket from one party to another. However, after the transfer is complete, both parties then possess a copy of the same purchased ticket. Therefore, security and anti-fraud measures are needed to prevent both parties from attempting to gain admission to an event using the same purchased ticket.

### SUMMARY OF THE CLAIMED INVENTION

A user purchases a ticket on a ticketing application. The ticketing application then stamps the ticket with a “fingerprint,” e.g., a barcode or a digital watermark, to uniquely identify the ticket. The ticketing application then stores the fingerprint. The user transfers the ticket to another recipient. In doing so, the ticketing application deletes the first ticket and its unique fingerprint from the server. Instead of transferring the original ticket to the user, the ticketing application generates a new ticket with a new fingerprint. The new fingerprint is stored in the server. Thus, the user cannot use the original ticket to access the event, thereby preventing the recipient to attend the event.

In a further embodiment, a user purchases a ticket from a vendor and imports the ticket into a ticketing application. The ticketing application then stamps the ticket with a “fingerprint,” e.g., a barcode or a digital watermark, to uniquely identify the ticket. The ticketing application then stores the fingerprint. The user transfers the ticket to another recipient and the ticketing application issues the ticket to the recipient.

### BRIEF DESCRIPTION OF THE FIGURES

FIG. 1 illustrates an exemplary computer-implemented method for implementing security and anti-fraud measures for ticket transfer;

FIG. 2A illustrates an exemplary graphical interface for purchasing and opening a ticket in a ticketing application;

FIG. 2B illustrates an exemplary graphical interface for assigning a fingerprint to a ticket;

FIG. 2C illustrates an exemplary graphical interface for transferring a ticket to a recipient;

FIG. 3 illustrates a computing system that may be used to implement the method of the present invention.

### DETAILED DESCRIPTION

Embodiments of the present invention provide a system and method for providing security and anti-fraud measures for use in connection with electronic ticket transfer, and may be used in conjunction with any ticket transfer system or method.

One or more tickets to an event may be electronically purchased by a user associated with a computing device. The purchased tickets may be digital, e-tickets, or print-at-home tickets (e.g., PDF, HTML, etc.). The event may be any private or public prerecorded, repeat, or live event or performance known in the art such as a concert, sporting event, show, movie, or musical recital. A purchased ticket may be electronically received by the user from the ticket seller or source and saved to a database accessible by the computing device. ,The user may choose to load or import on or more received tickets into an application for hosting electronic tickets and accessible by the computing device.

The steps of the method of the present invention may be embodied in hardware or software including a non-transitory computer-readable storage medium (e.g., an optical disc or memory card) having instructions executable by a processor of a computing device. A user may launch or activate the method by opening or activating an application (e.g., a ticketing application) in a computing device such as a mobile device. A ticketing application may be implemented by one or more processors that execute instructions stored in memory mediums. The executed code may result in the processor(s) generating one or more graphical interfaces.

According to the present invention, a user may purchase a ticket directly through the application, or from any available seller, re-seller, vendor or other source. Once loaded into the application, the purchased and/or received tickets may be assigned a unique fingerprint. Digital watermarking, or any other method known in the art to prevent ticket duplication or tampering may be used. The fingerprint may be recorded and stored, for example, on a server associated with the ticketing application.

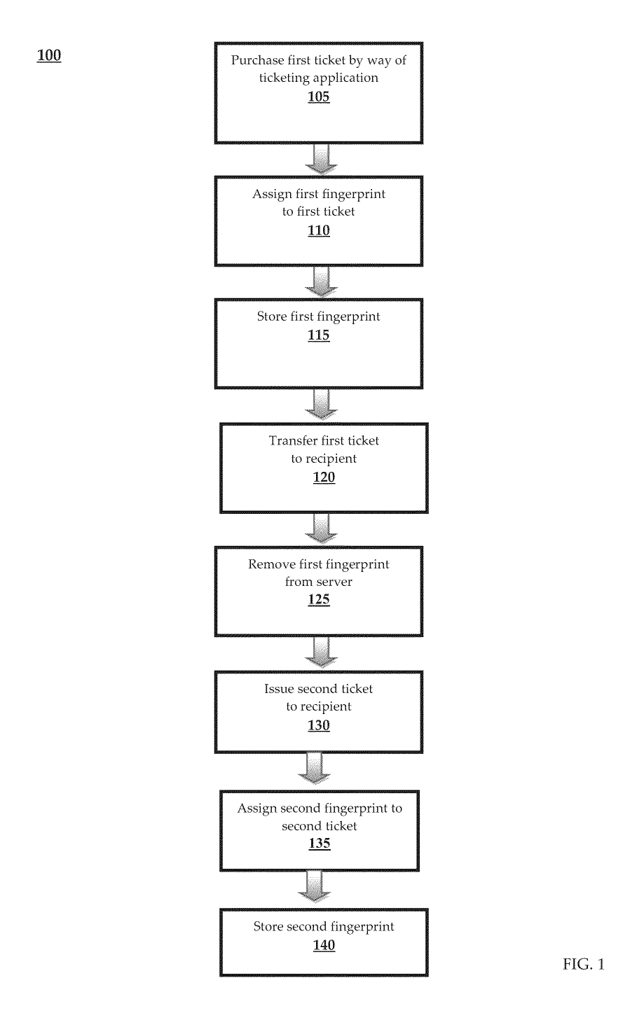

FIG. 1 illustrates an exemplary computer-implemented method 100 for implementing security and anti-fraud measures for ticket transfer. A user may purchase a ticket directly through the ticketing application at step 105 of FIG. 1. At the time of purchase, the user may be issued an electronic ticket with a unique fingerprint, at step 110 of FIG. 1. The unique fingerprint is stored in a server at step 115 at FIG. 1.

If the user successfully transfers the ticket to a second user through the ticketing application at step 120 of FIG. 1, the original electronic ticket issued to the user (and its fingerprint) may be deleted, for example, from the server of the ticketing application, at step 120 of FIG. 1. Following transfer of the electronic ticket to a recipient at step 125 of FIG. 1, the user may not access the deleted ticket, preventing the user from attempting to gain entrance to the event using the transferred ticket.

At steps 130 and 135 of FIG. 1, the ticketing application may issue a new electronic ticket with a new unique fingerprint to the transfer recipient. The new unique fingerprint is stored in the server at step 140 of FIG. 1. The transfer recipient may access the new electronic ticket using the ticketing application to gain entrance to the event. When the transfer recipient presents the electronic ticket at the event venue, the event venue may require ticket validation before admitting the transfer recipient to the event. For example, if the fingerprint of the ticket consists of a barcode or QR code, the venue may employ a scanner to validate the ticket. The scanner may send the ticket fingerprint to the server of the ticketing application, which will identify the fingerprint. If the fingerprint is identified on the server, the server may communicate to the scanner that the ticket is valid. If the fingerprint is not identified on the server, the server may communicate to the scanner that the ticket is invalid. Because a user may not be admitted to an event with an invalid ticket, the system and method of the present invention prevents fraud and ticket duplication.

In another embodiment, a user may purchase an electronic ticket from a re-seller, vendor, or source other than the application of the present invention. At the time of purchase, the user may be issued an electronic ticket with a unique fingerprint. If the user successfully transfers the ticket to a transfer recipient through the ticketing application, the fingerprint of the original ticket may remain in the server of the ticketing application because the ticketing application may be unable to generate and issue a new, valid ticket for the event.

The transfer recipient will be issued a ticket with the same fingerprint as the ticket that was issued to the user at the time of purchase. The transfer recipient may access the new electronic ticket using the ticketing application to gain entrance to the event. When the transfer recipient presents the electronic ticket at the event venue, the event venue may require ticket validation before admitting the transfer recipient to the event. For example, if the fingerprint of the ticket consists of a barcode or QR code, the venue may employ a scanner to validate the ticket. The scanner may send the ticket fingerprint to the server of the ticketing application, which will identify the fingerprint. If the fingerprint is identified on the server, the server may communicate to the scanner that the ticket is valid. If the fingerprint is not identified on the server, the server may communicate to the scanner that the ticket is invalid.

Despite having transferred the ticket to the transfer recipient, the user may still access the original ticket with the valid fingerprint through the ticketing application. The user may therefore attempt to use the ticket at the event, despite having transferred the ticket to the transfer recipient. To minimize incentive for fraud and ticket duplication, therefore, the present invention may allow free transfers of tickets between the user and the transfer recipient.

In another embodiment, the system and method of the present invention may charge the transfer recipient a fee for facilitating the ticket transfer between the user and the transfer recipient. The ticketing application may store the payment information from the transfer recipient, such as credit card information. The ticketing application may not release payment for the transfer fee from the transfer recipient to the user for the ticket transfer until the event has been completed. If the event is completed and the transfer recipient gains entrance to the event, the system may release payment of the ticket transfer fee to the user. If the event is completed and the transfer recipient was not able to gain entrance to the event, the ticketing application may not release payment of the ticket transfer fee to the user until the complaint has been investigated and resolved. Therefore, the user may be prevented from attempting fraud or ticket duplication in order to receive payment of the transfer fee.

The unique fingerprint of each ticket may be loaded into the ticketing application one time only, which prevents a user from loading the same purchased ticket into the ticketing application and transferring it to more than one recipient. Subsequent attempts to load a ticket into the ticketing application may be rejected when the ticketing application recognizes that the unique fingerprint of the ticket has already been loaded and stored in the server of the ticketing application.

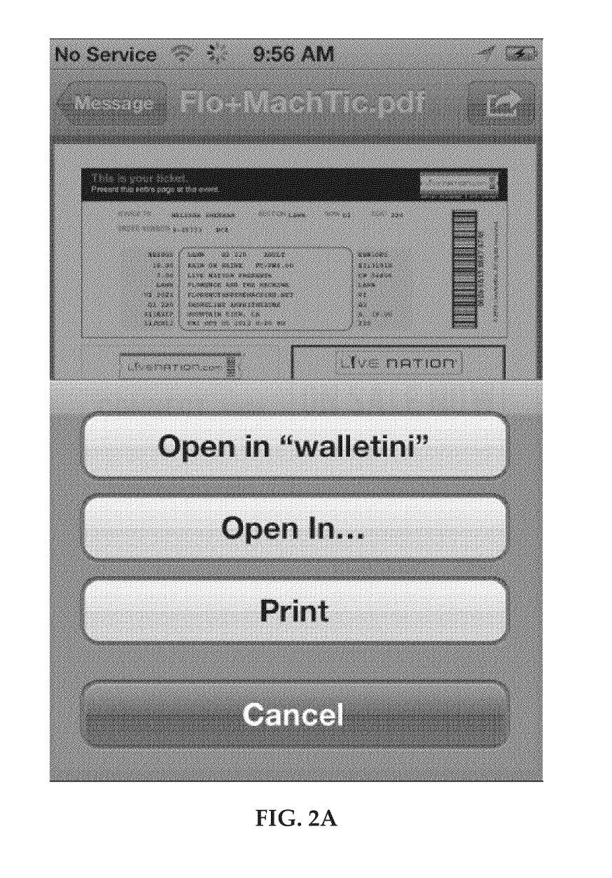

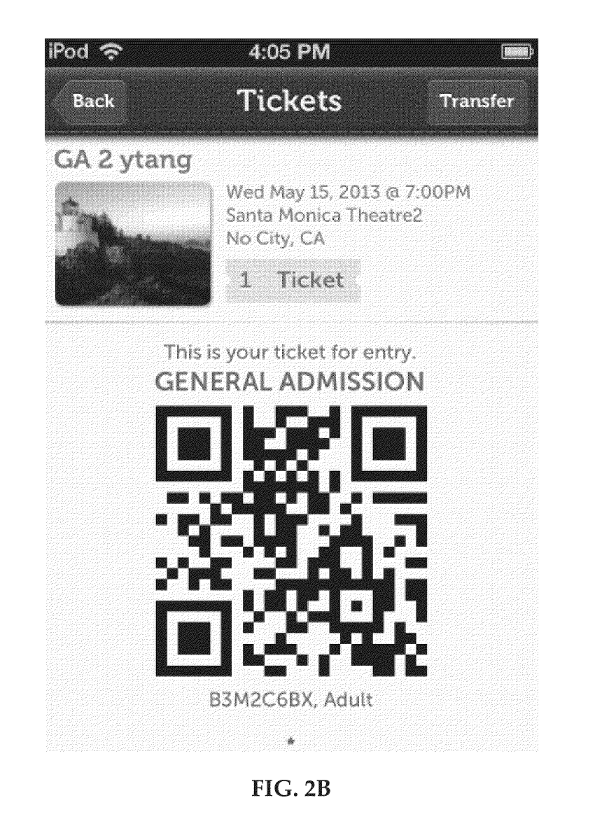

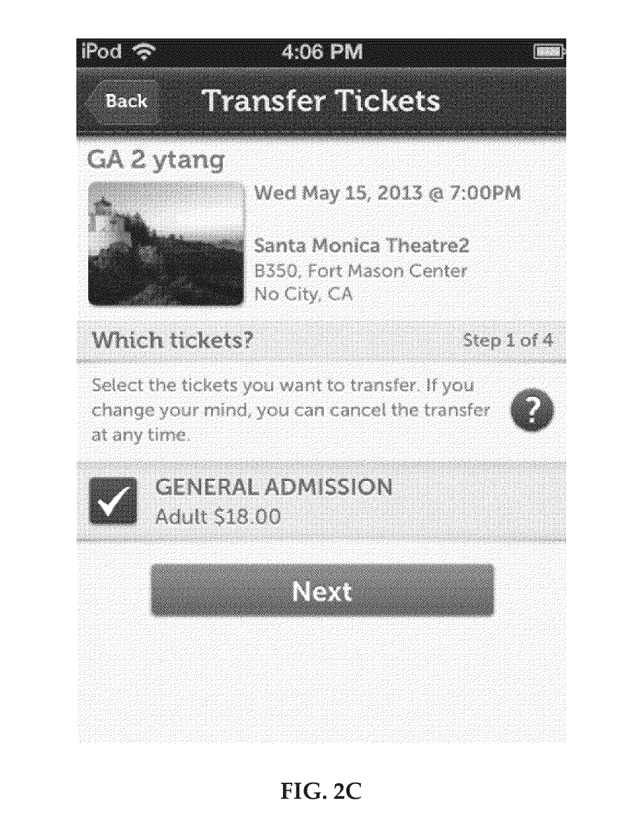

FIGS. 2A-2C illustrate exemplary interfaces for implementing security and anti-fraud measures for ticket transfer, as described in step 100 of FIG. 1.

FIG. 2A illustrates an exemplary graphical interface for purchasing and opening a ticket in a ticketing application, as described in step 105 of FIG. 1. The user may press a “Create Account” or similar button to register a user account. Alternatively, if the user has already registered, she may bypass this procedure by logging into the ticketing application using her secure credentials, such as a user name and password.

FIG. 2B illustrates an exemplary graphical interface for assigning a fingerprint to a ticket, as described in steps 110 and 135 of FIG. 1.

FIG. 2C illustrates an exemplary graphical interface for transferring a ticket to a recipient, as described in step 120 of FIG. 1.

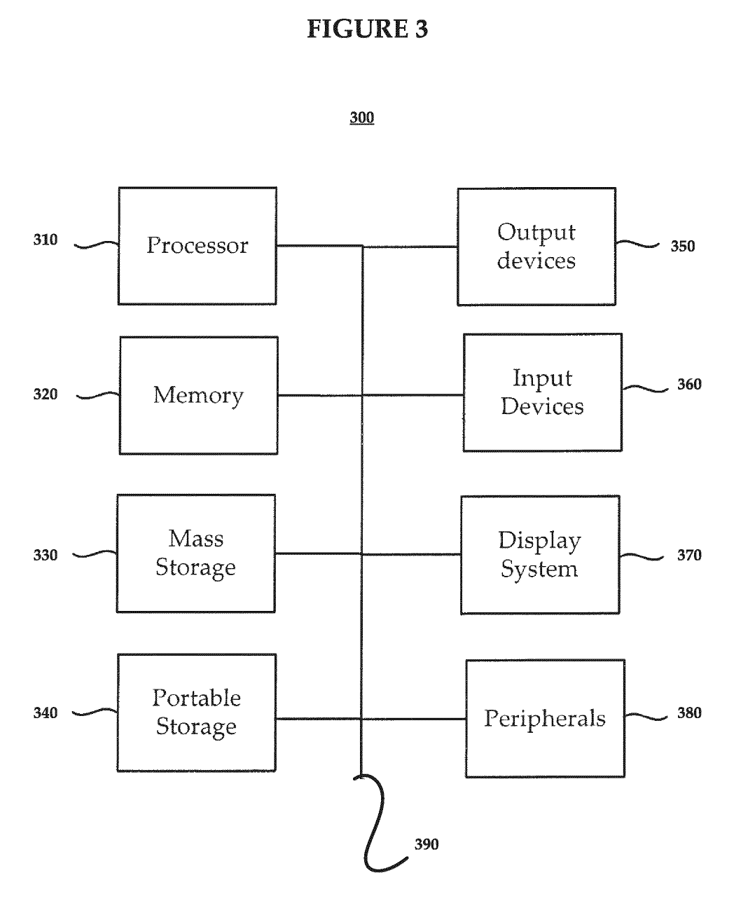

FIG. 3 illustrates a computing system 300 that may be used to implement an embodiment of the present invention. System 300 of FIG. 3 may be used to implement a computing device, network server, application server 150, and/or database operating in the context of the method of FIG. 1. The computing system 300 of FIG. 3 includes one or more processors 310 and memory 320. Main memory 320 stores, in part, instructions and data for execution by processor 310. Main memory 320 can store the executable code when in operation. The system 300 of FIG. 3 further includes a mass storage device 330, portable storage medium drive(s) 340, output devices 350, user input devices 360, a graphics display 370, and peripheral devices 380.

The components shown in FIG. 3 are depicted as being connected via a single bus 390. The components, however, may be connected through one or more data transport means. For example, processor unit 310 and main memory 320 may be connected via a local microprocessor bus, and the mass storage device 330, peripheral device(s) 380, portable storage device 340, and display system 370 may be connected via one or more input/output (I/O) buses.

Mass storage device 330, which may be implemented with a magnetic disk drive or an optical disk drive, is a non-volatile storage device for storing data and instructions for use by processor unit 310. Mass storage device 330 may store the system software for implementing embodiments of the present invention for purposes of loading software into main memory 320.

Portable storage device 340 operates in conjunction with a portable nonvolatile storage medium, such as a floppy disk, compact disk or Digital video disc, to input and output data and code to and from the computer system 300 of FIG. 3. The system software for implementing embodiments of the present invention may be stored on such a portable medium and input to the computer system 300 via the portable storage device 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 3 includes output devices 350. Examples of suitable output devices include speakers, printers, network interfaces, and monitors.

Display system 370 may include a liquid crystal display (LCD) or other suitable display device. Display system 370 may receive textual and graphical information, and process the information for output to the display device.

Peripherals 380 may include any type of computer support device to add additional functionality to the computer system. For example, peripheral device(s) 380 may include a modem or a router.

The components contained in the computing system 300 of FIG. 3 are those typically found in computer systems that may be suitable for use with embodiments of the present invention and are intended to represent a broad category of such computer components that are well known in the art. Thus, the computing system 300 of FIG. 3 may be a personal computer, hand held computing device, tablet device, telephone, mobile computing device, workstation, server, minicomputer, mainframe computer, or any other computing device. The computer may also include different bus configurations, networked platforms, multi-processor platforms, etc. Various operating systems may be used including Unix, Linux, Windows Mobile, or iOS. The steps of the method of FIG. 1 (and its various alternatives) may be performed by a module or engine stored on a computer readable storage medium (e.g., optical disc, memory card, etc.) comprising instructions executable by a processor of a computing device.

The above description is illustrative and not restrictive. Many variations of the invention will become apparent to those of skill in the art upon review of this disclosure. While the present invention has been described in connection with a variety of embodiments, these descriptions are not intended to limit the scope of the invention to the particular forms set forth herein. To the contrary, the present descriptions are intended to cover alternatives, modifications, and equivalents as may be included within the spirit and scope of the invention as defined by the appended claim and otherwise appreciated by one of ordinary skill in the art.

What is claimed is:

1. A computer-implemented method for preventing ticket transfer fraud, the method comprising:
facilitating the purchase of a first ticket by way of a ticketing application;
assigning a first fingerprint to the first ticket;
storing the first fingerprint on a server;
transferring the first ticket to a recipient;
removing the first fingerprint from the server;
issuing a second ticket to the recipient by way of the ticketing application;
assigning a second fingerprint to the second ticket; and
storing the second fingerprint on the server.

2. The method of claim 1, wherein the first ticket is purchased directly through the ticketing application.

3. The method of claim 1, wherein the first fingerprint is assigned to the first ticket using digital watermarking.

4. The method of claim 1, wherein the first fingerprint is assigned to the first ticket using a barcode.

5. The method of claim 1, wherein the first fingerprint is assigned to the first ticket using a quick response (QR) code.

6. The method of claim 1, further comprising validating the second fingerprint of the second ticket at the venue by:
receiving from a communication device at the venue the second fingerprint;
searching the server for the second fingerprint;
locating the second fingerprint in the server;
communicating to the venue communication device that the second fingerprint is valid.

7. The method of claim 1, wherein the first fingerprint of the first ticket cannot be stored on the server more than once.

8. The method of claim 1, wherein the second fingerprint of the second ticket cannot be stored on the server more than once.

9. A computer-implemented method for preventing ticket transfer fraud, the method comprising:
importing a ticket into a ticketing application;
assigning a fingerprint to the ticket;
storing the fingerprint on a server;
transferring the ticket to a recipient by way of the ticketing application; and
issuing the ticket to the recipient by way of the ticketing application.

10. The method of claim 9, wherein the ticket is purchased from a third party ticket vendor.

11. The method of claim 9, wherein the fingerprint is assigned to the ticket using digital watermarking.

12. The method of claim 9, wherein the fingerprint is assigned to the ticket using a barcode.

13. The method of claim 9, wherein the first fingerprint is assigned to the first ticket using a quick response (QR) code.

14. The method of claim 9, further comprising validating the fingerprint of the ticket at the venue by:
receiving from a communication device at the venue the fingerprint;
searching the server for the fingerprint;
locating the fingerprint in the server;
communicating to the venue communication device that the fingerprint is valid.

15. The method of claim 9, wherein the fingerprint of the ticket cannot be stored on the server more than once.
